(19) United States
(12) Patent Application Publication
(10) Pub. No.: US 2022/0035798 A1
(43) Pub. Date: Feb. 3, 2022

(54) DATA ANALYSIS SUPPORT APPARATUS, DATA ANALYSIS SUPPORT METHOD, AND COMPUTER-READABLE RECORDING MEDIUM

(71) Applicant: NEC Corporation, Minato-ku, Tokyo (JP)

(72) Inventor: Shohei HIRUTA, Tokyo (JP)

(73) Assignee: NEC Corporation, Minato-ku, Tokyo (JP)

(21) Appl. No.: 17/276,283

(22) PCT Filed: Sep. 18, 2018
(86) PCT No.: PCT/JP2018/034492

§ 371 Date: Mar. 15, 2021

(51) Int. Cl. G06F 16/23; G06F 16/2457

(52) U.S. Cl. CPC G06F 16/2393; G06F 16/24578

(57) ABSTRACT

Provided is a data analysis support apparatus 1 that includes: a relationship score calculation unit 2 configured to calculate, with respect to a combination of features extracted from target data, a relationship score indicating a relationship between pieces of data corresponding to respective features included in the combination; a visualization score calculation unit 3 configured to calculate a visualization score indicating an effectiveness of a visualization method corresponding to the combination using the relationship score corresponding to the combination; and a display information generation unit 4 configured to select the visualization method according to the visualization score, and generate visualization display information for displaying a display corresponding to the selected visualization method on the display device 22.

### TECHNICAL FIELD

The present invention relates to a data analysis support apparatus and a data analysis support method for analyzing data, and further relates to a computer readable recording medium that includes a program for realizing the same recorded thereon.

### BACKGROUND ART

It takes a large amount of time and effort to perform data analysis on large-scale data. Therefore, a visualization method has been proposed for visualizing target data in order to support analysis of large-scale data. However, in recent years, a wide variety of visualization methods have been proposed, and there are therefore cases where it takes too much time for an analyst to select a visualization method suitable for analyzing target data.

Therefore, a technique for presenting a visualization method to an analyst that analyzes target data has been known. According to the technique, a visualization method suitable for the analysis of the target data is selected, and the selected visualization method is presented to the analyst.

As a related technique, a data analysis support apparatus that presents a visualization method to an analyst is disclosed in Patent Document 1. With the data analysis support apparatus, first, preset information (vocabulary) is extracted from target data, and attributes corresponding to the extracted information are specified. Next, the data analysis support apparatus extracts a visualization method whose effectiveness is high as a candidate using the combination of specified attributes by referring to a table in which a combination of attributes, a visualization method, and effectiveness are associated, which has been created in advance. Then, the data analysis support apparatus presents the extracted visualization method having high effectiveness to the analyst.

### LIST OF RELATED ART DOCUMENTS

### Patent Document

Patent Document 1: Japanese Patent Laid-Open Publication No. 2016-081213

### SUMMARY OF INVENTION

### Technical Problems

However, in the data analysis support apparatus disclosed in Patent Document 1, the table in which a combination of attributes, a visualization method, and effectiveness are associated is created in advance. Therefore, when the data analysis support apparatus disclosed in Patent Document 1 is used, the same visualization method is always presented to an analyst with respect to a combination of attributes. Also, when an attribute that matches the specified attribute is not present in the table, the visualization method cannot be extracted.

Note that, in order to improve the efficiency of analyzing target data, it is important to present a visualization method suitable for analyzing the target data to an analyst, but it is also important to present a visualization method suitable for the analyst.

An example object of the present invention is to provide a data analysis support apparatus and a data analysis support method for improving the efficiency of analyzing target data by presenting a visualization method suitable for the analysis, and a computer-readable recording medium that includes a program recorded thereon.

### Solution to the Problems

To achieve the above-stated example object, a data analysis support apparatus according to an example aspect of the present invention includes:

a relationship score calculation unit configured to calculate, with respect to a combination of features extracted from target data, a relationship score indicating a relationship between pieces of data corresponding to respective features included in the combination;

a visualization score calculation unit configured to calculate a visualization score indicating an effectiveness of a visualization method corresponding to the combination using the relationship score corresponding to the combination; and

a display information generation unit configured to select the visualization method according to the visualization score, and generate visualization display information for displaying a display corresponding to the selected visualization method on the display device.

Also, to achieve the above-stated example object, a data analysis support method according to an example aspect of the present invention includes:

(a) a step of calculating, with respect to a combination of features extracted from target data, a relationship score indicating a relationship between pieces of data corresponding to respective features included in the combination;

(b) a step of calculating a visualization score indicating an effectiveness of a visualization method corresponding to the combination using the relationship score corresponding to the combination; and

(c) a step of selecting the visualization method according to the visualization score, and generating visualization display information for displaying a display corresponding to the selected visualization method on the display device.

Furthermore, to achieve the above-stated example object, a computer-readable recording medium according to an example aspect of the present invention is a computer-readable recording medium that includes a program recorded thereon, the program including instructions that cause the computer to carry out:

(a) a step of calculating, with respect to a combination of features extracted from target data, a relationship score indicating a relationship between pieces of data corresponding to respective features included in the combination;

(b) a step of calculating a visualization score indicating an effectiveness of a visualization method corresponding to the combination using the relationship score corresponding to the combination; and

(c) a step of selecting the visualization method according to the visualization score, and generating visualization display information for displaying a display corresponding to the selected visualization method on the display device.

### Advantageous Effects of the Invention

As described above, according to the present invention, the efficiency of analyzing target data can be improved by presenting a visualization method suitable for the analysis.

### BRIEF DESCRIPTION OF THE DRAWINGS

FIG. 1 is a diagram illustrating an example of a data analysis support apparatus.

FIG. 2 is a diagram illustrating an example of a system including the data analysis support apparatus.

FIG. 3 is a scatter diagram illustrating the relationship between a number of transmitted bytes and a number of received bytes.

FIG. 4 is a diagram illustrating an example of a data structure of feedback management information.

FIG. 5 is a diagram illustrating an example of a data structure of partial feedback management information.

FIG. 6 is a diagram illustrating an example of a data structure of visualization method information.

FIG. 7 is a diagram illustrating an example of a display corresponding to visualization methods.

FIG. 8 is a diagram illustrating an example of a display corresponding to visualization methods.

FIG. 9 is a diagram illustrating an example of operations for displaying a display corresponding to a visualization method.

FIG. 10 is a diagram illustrating an example of operations for calculating a feedback score.

FIG. 11 is a diagram illustrating an example of a computer that realizes the data analysis support apparatus.

### EXAMPLE EMBODIMENT

### Example Embodiment

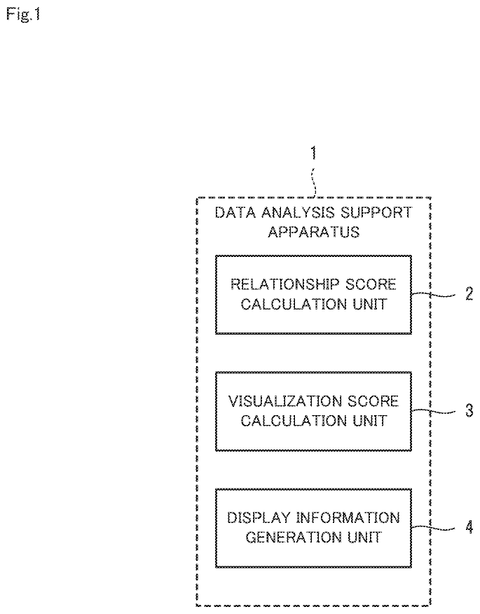

Hereinafter, an example embodiment of the present invention will be described with reference to FIGS. 1 to 11.

[Apparatus Configuration]

First, the configuration of a data analysis support apparatus 1 according to the present example embodiment will be described using FIG. 1. FIG. 1 is a diagram illustrating an example of the data analysis support apparatus.

The data analysis support apparatus 1 shown in FIG. 1 is an apparatus for improving the efficiency of an analysis by presenting a visualization method suitable for the analysis. Also, as shown in FIG. 1, the data analysis support apparatus 1 includes a relationship score calculation unit 2, a visualization score calculation unit 3, and a display information generation unit 4.

Among these units, the relationship score calculation unit 2 calculates, with respect to a combination of features extracted from target data, a relationship score indicating the relationship between pieces of data corresponding to features included in the combination. The visualization score calculation unit 3 calculates a visualization score indicating the effectiveness of a visualization method corresponding to the combination using a relationship score corresponding to the combination. The display information generation unit 4 selects a visualization method according to the visualization score, and generates visualization display information for outputting a display corresponding to the selected visualization method to a display device.

In this way, in the present example embodiment, the visualization method is selected according to the visualization score, and the selected visualization method suitable for the analysis is presented to an analyst. Therefore, the time needed for an analyst to select a visualization method suitable for the analysis can be reduced.

[System Configuration]

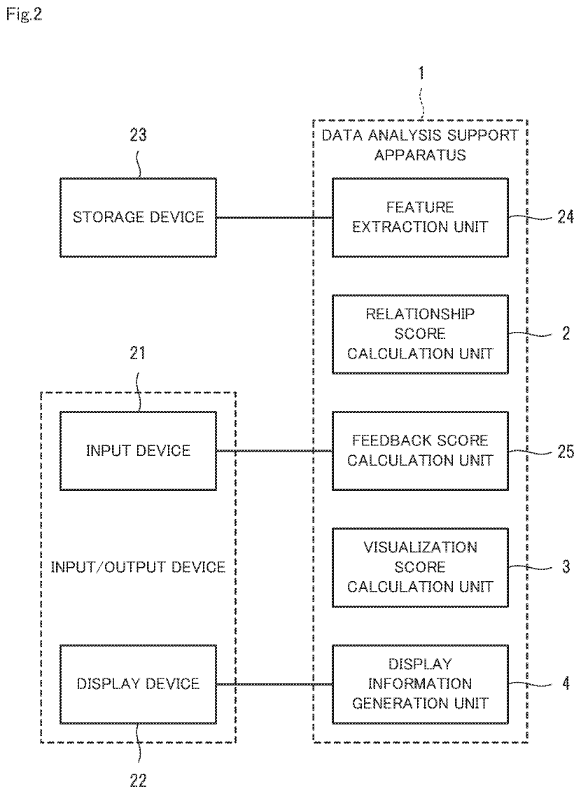

Next, the configuration of the data analysis support apparatus 1 according to the present example embodiment will be more specifically described using FIG. 2. FIG. 2 is a diagram illustrating an example of a system including the data analysis support apparatus.

As shown in FIG. 2, the system according to the present example embodiment includes a data analysis support apparatus 1, an input device 21, a display device 22, and a storage device 23. The input device 21 is a device for inputting information to the data analysis support apparatus 1. The display device 22 is a device for outputting information that is output from the data analysis support apparatus 1. The storage device 23 may be provided outside the data analysis support apparatus 1, as shown in FIG. 2, or may be provided inside the data analysis support apparatus 1.

The input device 21 is a device for inputting information that is input by an analyst to the data analysis support apparatus 1 using a keyboard, mouse, touch panel, and the like, for example.

The display device 22 is an image display device using liquid crystal, organic EL (Electro Luminescence), or a CRT (Cathode Ray Tube), for example. Moreover, the display device 22 may also include an audio output device such as a speaker, and the like. Note that the display device 22 may also be a printing device such as a printer. Also, in the example in FIG. 2, the input device 21 and the display device 22 are separately illustrated, but may be configured by an input/output device (range surrounded by broken lines in FIG. 2). In this case, the input/output device is a device such as a personal computer or a server computer that is connected to a monitor, for example.

Next, the data analysis support apparatus 1 includes a feature extraction unit 24 and a feedback score calculation unit 25, in addition to the relationship score calculation unit 2, the visualization score calculation unit 3, and the display information generation unit 4.

The feature extraction unit 24 extracts a combination of features from target data to be analyzed. Specifically, in order to understand the tendency of target data to be analyzed, the feature extraction unit 24 extracts the target data from the storage device 23 in which the target data is stored.

Next, the feature extraction unit 24 extracts a plurality of features (feature 1, feature 2, . . . , feature n: n is a positive integer) from the acquired target data. When communication traffic is analyzed, the feature extraction unit 24 extracts, with respect to a transmission source IP (Internet Protocol) address and a transmission destination IP address, information indicating features such as date and time (Time), a transmission source port number (SrcPort), a transmission destination port number (DstPort), a number of transmitted bytes (SrcByte), a number of received bytes (DstByte), a communication time (Duration), a number of transmitted packets, and a number of received packets from the target data, for example.

Thereafter, the feature extraction unit 24 generates combination information by combining the extracted features (feature 1, feature 2, . . . , feature n). For example, in the analysis of the communication traffic, when six types of features are extracted from the target data, and the combination information is generated by combining two features among them, the feature extraction unit 24 generates (feature 1, feature 2), (feature 1, feature 3), (feature 1, feature 4), (feature 1, feature 5), (feature 1, feature 6), (feature 2, feature 3), (feature 2, feature 4), (feature 2, feature 5), (feature 2, feature 6), (feature 3, feature 4), (feature 3, feature 5), (feature 3, feature 6), (feature 4, feature 5), (feature 4, feature 6), (feature 5, feature 6).

The relationship score calculation unit 2 calculates an index indicating the relationship between pieces of data corresponding to the features included in combination information. Specifically, the relationship score calculation unit 2, first, acquires combination information. Next, the relationship score calculation unit 2 calculates a relationship score S_{R} indicating the relationship between pieces of data corresponding to features, for each visualization method, using data corresponding to each of the features included in the combination information. As the visualization method, there are method using a scatter diagram, a polygonal line graph, bar graph, and the like. Also, a method of changing the scale may be included in the visualization method.

The calculation of the relationship score S_{R} will be described in detail. The visualization method includes (A) a method of displaying an absolute value of a correlation coefficient using a scatter diagram, (B) a method of displaying a clustering result (quantitative evaluation scale) using a scatter diagram, (C) a method of displaying a data distribution using a polygonal line graph, and (D) a method of displaying a data evaluation using a bar graph, for example.

When the relationship score S_{R} in the visualization method (A) is calculated, the relationship score S_{R} is calculated using formula (1), for example.

$$\begin{matrix} [ Math . 1 ] & \\ {S}_{R} ( {f}_{x} , {f}_{y} ) = \vert \frac{\frac{1}{N} {\sum }_{i = 1}^{N} ( {d}_{{f}_{x} , i} - \overline{{d}_{{f}_{x}}} ) ( {d}_{{f}_{y} , i} - \overline{{d}_{{f}_{y}}} )}{\sqrt{\frac{1}{N} {\sum }_{i = 1}^{N} {( {d}_{{f}_{x} , i} - \overline{{d}_{{f}_{x}}} )}^{2}} \sqrt{\frac{1}{N} {\sum }_{i = 1}^{N} {( {d}_{{f}_{y} , i} - \overline{{d}_{{f}_{y}}} )}^{2}}} \vert & ( 1 )\end{matrix}$$

S_{R}: Relationship score
fₓ, f_{y}: Features
d: Target data
N: Number of data
d_{f}_{ₓ}_{,i}, d_{f}_{_{y}}_{,i}: i^{th} data of features
d̅_̅{̅f̅}̅_̅{̅ₓ̅}̅, d̅_̅{̅f̅}̅_̅{̅_̅{̅y̅}̅}̅: Average value of data corresponding to features

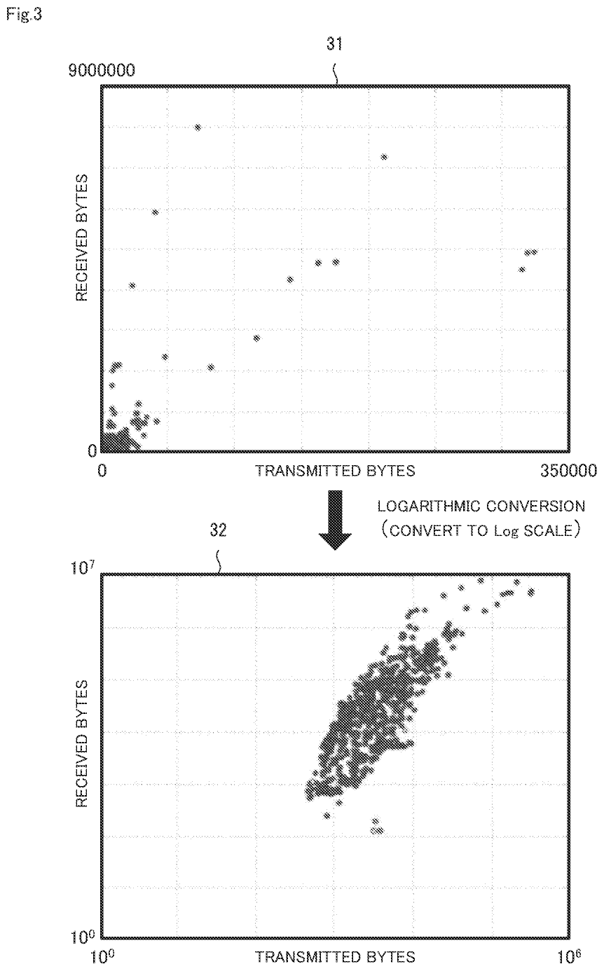

A case where, in formula (1), the relationship score S_{R} is calculated using a scatter diagram in FIG. 3 will be described. FIG. 3 is a scatter diagram illustrating the relationship between a number of transmitted bytes and a number of received bytes. In FIG. 3, the relationship score S_{R} is calculated by setting the number of transmitted bytes (SrcByte) and the number of received bytes (DstByte) in the analysis of the communication traffic respectively as features fₓ and f_{y} in formula (1).

Note that target data d indicates data to be analyzed. Also, the features fₓ, and f_{y} indicate the combination information generated by the feature extraction unit 24. For example, when the target data d is data represented by (SrcIP, DstIP, SrcByte, DstByte, SrcPacket, and DstPacket), pieces of the combination information of features are (SrcIP, DstIP), (SrcIP, SrcByte), and so on, and the features fₓ and f_{y} corresponds to each combination information.

Note that a scatter diagram 31 shown in FIG. 3 is a diagram obtained by plotting the number of transmitted bytes (SrcByte) and the number of received bytes (DstByte) as is, in the analysis of the communication traffic. In contrast, a scatter diagram 32 shown in FIG. 3 is a diagram obtained by logarithmic-converting the number of transmitted bytes (SrcByte) and the number of received bytes (DstByte) and plotting them.

Also, when the relationship score S_{R} is calculated using formula (1) with respect to each of the scatter diagram 31 and the scatter diagram 32, the relationship score S_{R} of the scatter diagram 32 has a larger value than the relationship score S_{R} of the scatter diagram 31. That is, as is apparent from FIG. 3, the visualization method of the scatter diagram 32 can display the relationship between the transmitted bytes and the received bytes in a form that is easily understandable for the analyst compared with the visualization method of the scatter diagram 31. In other words, because the target data points are scattered in the scatter diagram 31, the correlation tendency is not easily understandable, but the target data points are densely distributed in the scatter diagram 32, and the display is performed such that the correlation tendency is easily understandable.

When the relationship score S_{R} in the visualization method (B) is calculated, the relationship score S_{R} is calculated using PseudoF, for example. In PseudoF, the relationship score S_{R} takes a larger value, as the generated clusters are located more sparsely, and the elements in each cluster are more densely located. Refer to formula (2).

$$\begin{matrix}[ Math . 2 ] & \\ {S}_{R} = \frac{BCSM ( n - k )}{WCSM ( k - 1 )} \\ BCSM = {\sum }_{i}^{k} {( {z}_{i} - {z}_{tot} )}^{2} {n}_{i} \\ WCSM = {\sum }_{i}^{k} {\sum }_{j}^{{n}_{i}} {( {x}_{ij} - {z}_{i} )}^{2} & ( 2 )\end{matrix}$$

S_{R}: Relationship score
n: Total number of data
k: Number of clusters
zᵢ: Center of ith cluster
zₜₒₜ: Center of all data
nᵢ: Number of data in ith cluster
xᵢⱼ: jth data in ith cluster

When the relationship score S_{R} in the visualization method (C) is calculated, a normal distribution is used, “the normal distribution being followed” is set up as a null hypothesis, and the significance level is set to 5 [%], for example. Also, the relationship score S_{R} is calculated using a Kolmogorov-Smirnov test, a Shapiro-Wilk test, or the like as the test method. Refer to formula (3).

$$\begin{matrix}[ Math . 3 ] & \\ {S}_{R} = \{ \begin{matrix}0 , & ( p \leq 0.05 ) \\ 1 , & ( p > 0.05 )\end{matrix} & ( 3 )\end{matrix}$$

S_{R}: Relationship score
p: p-value (significance probability)

When the relationship score S_{R} in the visualization method (D) is calculated, the relationship score S_{R} is calculated using formula (4), for example.

$$\begin{matrix}[ Math . 4 ] & \\ {S}_{R} ( f ) = \{ \begin{matrix}0 & ( \vert {d}_{f} \vert = 1 ) \\ 1 & ( 2 \leq \vert {d}_{f} \vert \leq 10 ) \\ \frac{10}{\vert {d}_{f} \vert} & ( 11 < \vert {d}_{f} \vert )\end{matrix} & ( 4 )\end{matrix}$$

S_{R}: Relationship score
d: Target data

### f: Feature

|d_{f}|: Number of data of features

Note that the relationship score S_{R} is formularized such that the visualization method is more suitable for the analysis of the target data as the calculated relationship score S_{R} increases.

The feedback score calculation unit 25 calculates an index indicating the easiness of an analysis felt by an analyst (user-friendliness), whether or not being suitable for the analysis, or the like, when the analyst has analyzed target data using a visualization method corresponding to the combination of features, when the analyst has used the visualization method corresponding to the combination of features.

Specifically, the feedback score calculation unit 25 first acquires feedback information indicating the evaluation degree of the analyst with respect to the visualization method regarding the combination of features from the input device 21. The feedback information is input by the analyst using the input device 21, for example. Alternatively, the usage history of the visualization method used by the analyst may be input.

Also, the evaluation degree is a value obtained by quantifying the impression felt by the analyst with respect to the visualization method regarding the combination, or the like. Also, the inputting method of the evaluation degree includes a method in which when the visualization method used for an analysis has been determined to be suitable for the analysis, the analyst is allowed to select “Good” or not, and the selected item is input as the evaluation degree, for example. The method may be a method of selecting one from two choices such as “Good” and “Bad”, or a method of selecting one from three or more different ranks that are set in advance. Alternatively, the method may be a method of inputting a numerical value or a character indicating the evaluation degree, or an inputting method in which these are combined.

Next, the feedback score calculation unit 25 calculates a feedback score serving as the index described above based on the acquired feedback information.

Specifically, the feedback score calculation unit 25 generates, for each analyst, feedback management information (first feedback management information) in which a combination of features, a visualization method, a number of feedbacks (first number of feedbacks) for acquiring feedback information regarding a combination between the combination of features and the visualization method, and an evaluation degree indicated by the feedback information are associated.

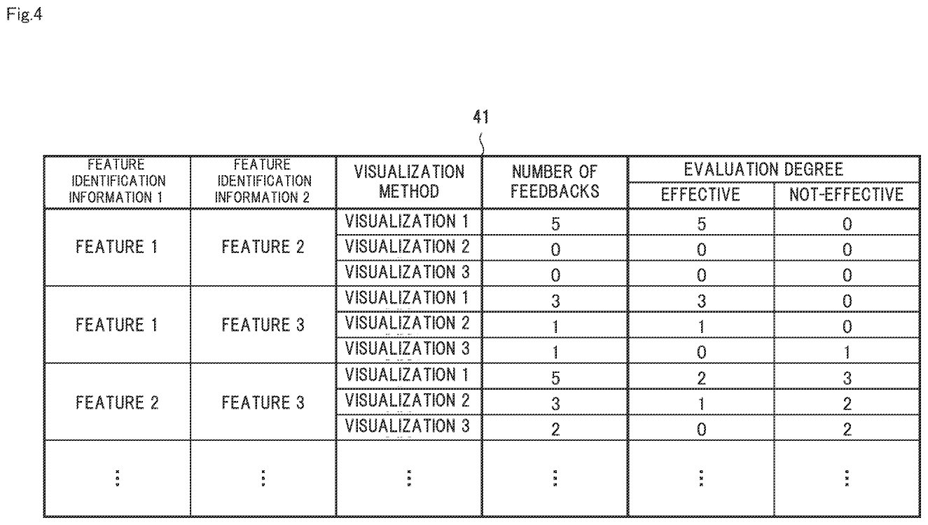

FIG. 4 is a diagram illustrating an example of a data structure of the feedback management information. The feedback management information 41 is stored in the storage device 23, a storage unit provided in the data analysis support apparatus 1, or a storage unit provided outside the data analysis support apparatus 1, for example. The feedback management information 41 is information in which “feature identification information 1” and “feature identification information 2” for indicating the combination of features, a “visualization method” that indicates the visualization method, a “number of feedbacks” that indicates the number of feedbacks, and “effective” and “not-effective” for indicating the evaluation degree are associated.

Also, information “feature 1”, “feature 2”, “feature 3”, or the like indicating the feature is stored in the “feature identification information 1” and “feature identification information 2”. Information “visualization method 1”, “visualization method 2”, “visualization method 3”, or the like indicating the visualization method is stored in the “visualization method”. The number of times that the feedback score calculation unit 25 has acquired the feedback information (number of feedbacks) is stored in the “number of feedbacks”. The number of times feedback information is acquired that includes “Good” as described above is stored in “effective”, for example, and the number of times feedback information is acquired that includes “Bad” is stored in “not-effective”, for example.

Also, the feedback score calculation unit 25 generates, for each analyst, partial feedback management information (second feedback management information) in which a feature, a visualization method, a number of partial feedbacks (second number of feedbacks) that the partial feedback information regarding the combination between the feature and the visualization method is acquired, an evaluation degree indicated by the feedback information, and evaluation information calculated using the evaluation degree are associated.

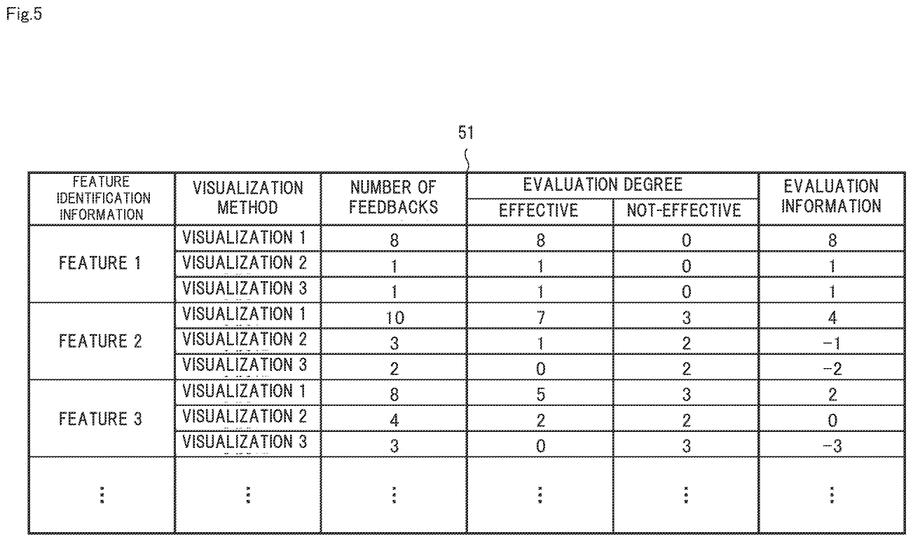

FIG. 5 is a diagram illustrating an example of a data structure of the partial feedback management information. The partial feedback management information 51 is stored in the storage device 23, a storage unit provided in the data analysis support apparatus 1, or a storage unit provided outside the data analysis support apparatus 1, for example. The partial feedback management information 51 is information in which “feature identification information” indicating the feature, a “visualization method” indicating the visualization method, a “number of partial feedbacks” indicating the number of feedbacks for each feature, “effective” and “not-effective” for indicating the evaluation degree, “evaluation information” indicating the evaluation information are associated.

Also, “feature 1”, “feature 2”, or the like for indicating the feature is stored in the “feature identification information”. Information such as “visualization method 1”, “visualization method 2”, or “visualization method 3” for indicating the visualization method is stored in the “visualization method”. The number of acquired pieces of feedback information is stored in the “number of partial feedbacks” for each feature. The number of acquired pieces of feedback information that are “Good” as described above with respect to the feature is stored in “effective”, for example, and the number of acquired pieces of feedback information that are “Bad” as described above with respect to the feature is stored in “not-effective”, for example. The value obtained by subtracting the value in “not-effective” from the value in “effective” is stored in the “evaluation information”.

Next, the feedback score calculation unit 25 calculates a feedback score S_{F} using the evaluation information, the number of partial feedbacks, and the number of combinations of the features (number of dimensions). Specifically, the feedback score calculation unit 25 calculates the feedback score S_{F} using formula (5).

$$\begin{matrix}[ Math . 5 ] & \\ {S}_{F} ( f , v ) = \frac{1}{N} {\sum }_{i = 1}^{N} freq ( {f}_{i} , v ) & ( 5 )\end{matrix}$$

S_{F}: Feedback score
freq: Function for obtaining partial feedback information

### f: Feature

V: Visualization method
N: Number of combinations of features (number of dimensions)

Note that the function freq for obtaining the partial feedback information is, in the case of the partial feedback management information 51 shown in FIG. 5, freq(feature 2, visualization 1)=4/10=0.4, in the case of a combination of “feature 2” and “visualization 1”.

Also, the feedback score S_{F} indicates that the visualization method is more suitable for the analyst as the feedback score S_{F} increases.

The visualization score calculation unit 3 calculates, for each analyst, the visualization score S_{V} indicating the effectiveness of a visualization method corresponding to a combination of features using the relationship score S_{R} calculated with respect to the visualization method corresponding to the combination of features. Alternatively, the visualization score calculation unit 3 calculates, for each analyst, a visualization score S_{V} using a relationship score S_{R} and a feedback score S_{F} that have been calculated with respect to a visualization method corresponding to a combination of features.

Specifically, the visualization score calculation unit 3 calculates the visualization score S_{V} using formula (6).

[Math. 6]

S_{V}=F(S_{R},S_{F}) (6)

S_{V}: Visualization score
S_{R}: Relationship score
S_{F}: Feedback score
F: Function for obtaining visualization score

For example, the function F may calculate the visualization score S_{V} using only the relationship score S_{R} corresponding to the combination. Also, the function F may be a function for adding the relationship score S_{R} and the feedback score S_{F}. Moreover, the function F may calculate the visualization score S_{V} using formula (7).

[Math. 7]

S_{V}=F(S_{R},S_{F})=wS_{R}+(1−w)S_{F} (7)

w: Weighting coefficient

The weighting coefficient w is a coefficient for determining which of the relationship score S_{R} and the feedback score S_{F} is weighted higher. The weighting coefficient w (0<w<1) is obtained by an experiment, a simulation, or the like.

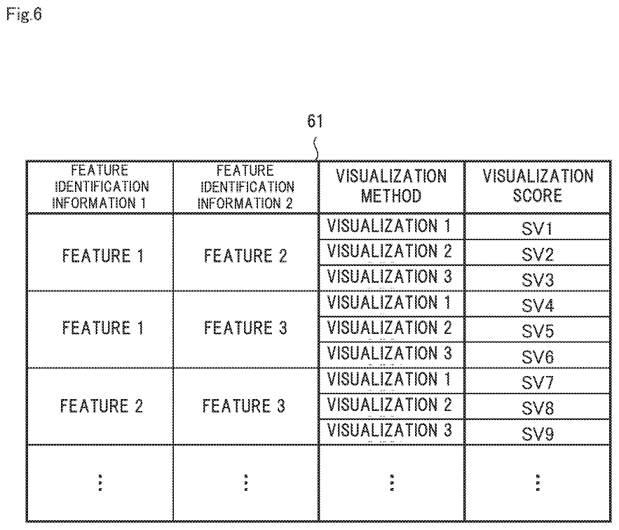

Next, the visualization score calculation unit 3 stores a combination of features, a visualization method corresponding to the combination, and the calculated visualization score S_{V}, in an associated manner, in the storage device 23, a storage unit provided in the data analysis support apparatus 1, or a storage unit provided outside the data analysis support apparatus 1. FIG. 6 is a diagram illustrating an example of a data structure of visualization method information. The visualization method information 61 is stored in the storage device 23, a storage unit provided in the data analysis support apparatus 1, or a storage unit provided outside the data analysis support apparatus 1, for example.

The visualization method information 61 is information in which “feature identification information 1” and “feature identification information 2” for indicating the combination of features, a “visualization method” indicating the visualization method, and a “visualization score” indicating the visualization score are associated.

Also, “feature 1”, “feature 2”, or the like for indicating the feature is stored in the “feature identification information 1” and the “feature identification information 2”. “visualization method 1”, “visualization method 2”, “visualization method 3” or the like for indicating the visualization method is stored in the “visualization method”. “SV1” to “SV9”, or the like for indicating the visualization score is stored in the “visualization score”.

The display information generation unit 4 selects a visualization method according to the visualization score S_{V} for each combination of features, and generates visualization display information for displaying a display corresponding to the selected visualization method in the display device 22. Also, the display information generation unit 4 changes the display corresponding to the visualization method according to the visualization score S_{V}.

Specifically, the display information generation unit 4, first, selects a visualization score S_{V} having the largest value, for each combination of features, by referring to the visualization scores S_{V} associated with respective visualization methods corresponding to the combination of features. In the example in FIG. 6, if the values of the visualization score is in the order of “SV1”>“SV2”>“SV3” when a visualization method suitable for the combination of features of “feature 1” and “feature 2” is selected, the display information generation unit 4 selects “visualization method 1” corresponding to “SV1” as the visualization method suitable for analyzing the combination of features of “feature 1” and “feature 2”.

Alternatively, the display information generation unit 4 selects a visualization score S_{V} that is a threshold value or more, for each combination of features, by referring to the visualization scores S_{V} associated with respective visualization methods corresponding to the combination of features. In the example in FIG. 6, when a visualization method suitable for the combination of features of “feature 1” and “feature 2” is selected, if only “SV1” has a value of visualization score that is equal to or larger than the threshold value, the display information generation unit 4 selects “visualization method 1” corresponding to “SV1” as the visualization method suitable for analyzing the combination of features of “feature” and “feature 2”. Note that the threshold value is obtained by an experiment, a simulation, or the like.

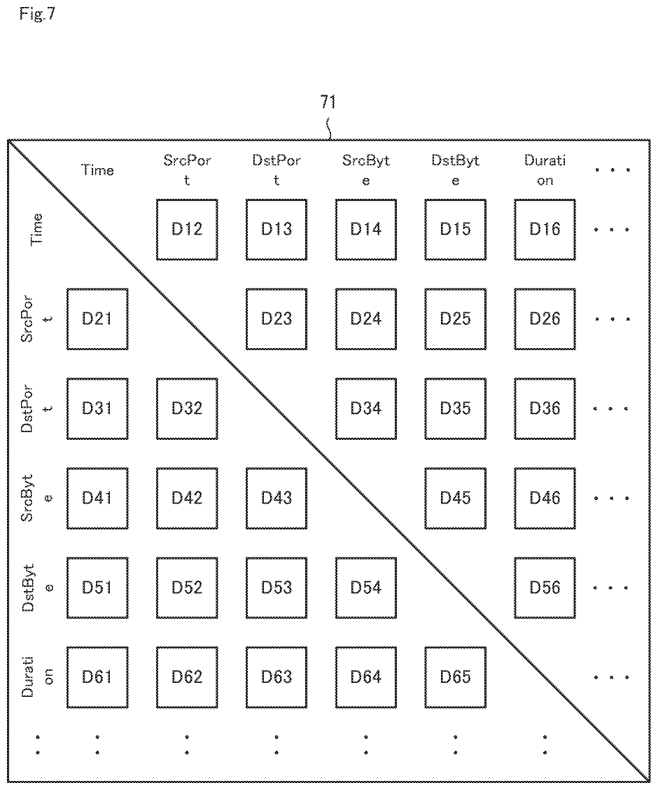

Next, the display information generation unit 4 generates visualization display information for displaying the visualization method selected for each combination of features in the display device 22. Specifically, the display information generation unit 4 generates information for displaying a display as shown in FIG. 7 in the display device 22.

FIG. 7 is a diagram illustrating an example of a display corresponding to visualization methods. The display shown in FIG. 7 is an example of displaying, in the case of assuming that features such as date and time (Time), a transmission source port number (SrcPort), a transmission destination port number (DstPort), a number of transmitted bytes (SrcByte), a number of received bytes (DstByte), a communication time (Duration), a number of transmitted packets, and a number of received packets are present with respect to a transmission source IP (Internet Protocol) address and a transmission destination IP address, when the communication traffic is to be analyzed, displays “D12” to “D16”, “D21”, “D23” to “D26”, “D31”, “D32” to “D34”, “D36”, “D41” to “D43”, “D45” “D46”, “D351” to “D54”, “D56”, “D61” to “D65”, and the like that correspond to visualization methods, for example.

In the example in FIG. 7, the display information generation unit 4 displays, for each combination of features, a display corresponding to a visualization method in which the visualization score S_{V} takes a maximum value, in the display device 22. For example, in the case of a combination of the date and time (Time) and the transmission source port number (SrcPort), a display “D21” corresponding to the visualization method of which the visualization score S_{V} takes a maximum value is displayed in the display device 22.

Also, the display information generation unit 4 may display, for each combination of features, one or more displays corresponding to visualization methods in which the visualization score S_{V} is the threshold value or more, in the display device 22. As the display method, for example, displays corresponding to visualization methods of the threshold value or more such that the analyst can understand that the visualization score S_{V} is large are displayed in the display device 22.

As an example of performing a display that is understandable for the analyst, a visualization method regarding which the visualization score S_{V} takes a maximum value is displayed by a normal display, a visualization method regarding which the visualization score S_{V} is smaller than the maximum value and is the threshold value or more is displayed by a display different from the normal display such as a semitransparent display.

Moreover, the display information generation unit 4, when a display of a visualization method corresponding to a combination of features that is displayed in the display device 22 is selected by the analyst using the input device 21, generates information for displaying a display of another visualization method corresponding to the combination of features in the display device 22.

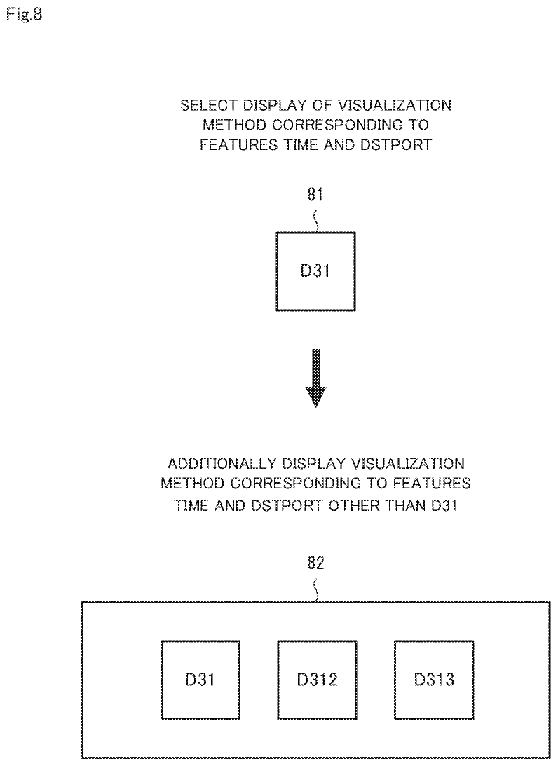

FIG. 8 is a diagram illustrating an example of a display corresponding to visualization methods. As shown in FIG. 8, when a display “D31” (81 in FIG. 8) of a visualization method corresponding to a combination of the date and time (Time) and the transmission destination port number (DstPort) is selected by the analyst using the input device 21, displays “D312” and “D313” of other visualization methods corresponding to the combination of features are displayed in addition to the display “D31”, for example.

Note that the display of a visualization method corresponding to a combination of features is a display of an icon or the like such that the visualization method can be recognized as a scatter diagram, a polygonal line graph, a bar graph, or the like. Also, the result of actually performing an analysis on target data using a visualization method may also be displayed as an icon.

[Apparatus Operations]

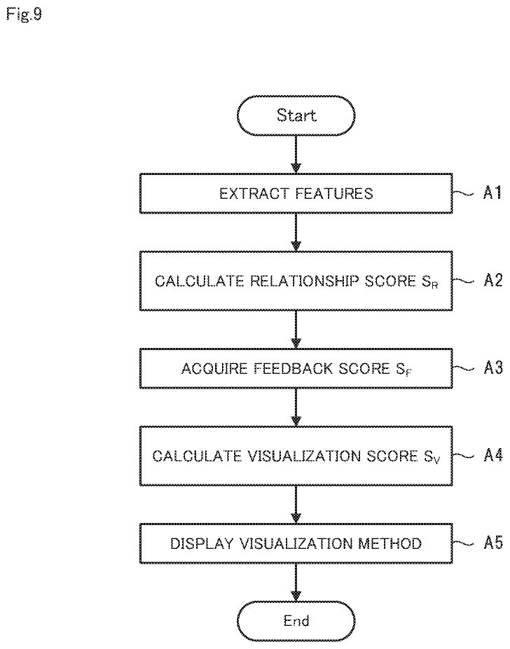

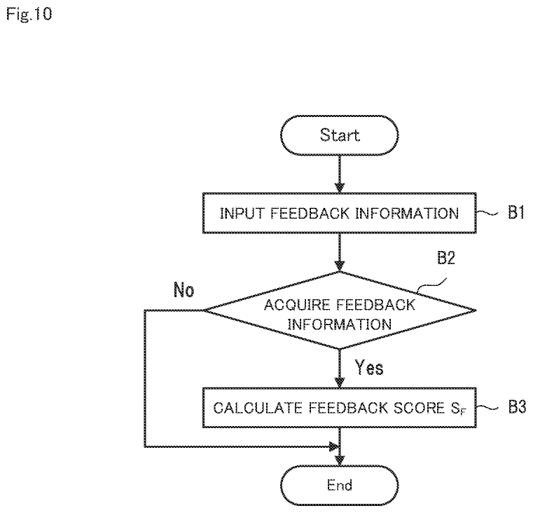

Next, the operations of the data analysis support apparatus 1 according to the present example embodiment will be described using FIGS. 9 and 10. FIG. 9 is a diagram illustrating an example of operations for displaying a display corresponding to a visualization method. FIG. 10 is a diagram illustrating an example of operations for calculating a feedback score. In the following description, FIGS. 2 to 8 will be referred to as appropriate. Furthermore, in the present example embodiment, the data analysis support method is carried out by causing the data analysis support apparatus 1 to operate. Therefore, the following description of the operations of the data analysis support apparatus 1 applies to the data analysis support method according to the present example embodiment.

The operations for causing the display device 22 to display a display corresponding to a visualization method will be described using FIG. 9. As shown in FIG. 9, first, the feature extraction unit 24 extracts combinations of features from target data to be analyzed (step A1). Specifically, in step A1, the feature extraction unit 24 acquires target data from the storage device 23 in which the target data is stored in order to understand the tendency of the target data that is to be analyzed. Next, in step A1, the feature extraction unit 24 extracts a plurality of features from the acquired target data.

Next, the relationship score calculation unit 2 calculates, with respect to a combination of features extracted from the target data, a relationship score indicating the relationship between pieces of data corresponding to the features included in the combination (step A2). Specifically, in step A2, the relationship score calculation unit 2 acquires combination information. Next, in step A2, the relationship score calculation unit 2 calculates an index indicating the relationship between pieces of data corresponding to the features included in the combination information. That is, in step A2, the relationship score calculation unit 2 calculates, using data corresponding to each feature included in the combination information, the relationship score S_{R} indicating the relationship between the pieces of data corresponding to the features for each visualization method.

For example, the relationship scores S_{R} are calculated with respect to the visualization methods shown in (A) to (D) described above and the like using the formulas (1) to (4) and the like.

Next, the visualization score calculation unit 3 acquires feedback scores S_{F} that are calculated in advance and are stored in the storage device 23, a storage unit provided in the data analysis support apparatus 1, or a storage unit provided outside the data analysis support apparatus 1 (step A3).

Next, if the feedback score S_{F} is not present, the visualization score calculation unit 3 calculates, using a relationship score S_{R} calculated with respect to a visualization method corresponding to a combination of features, the visualization score S_{V} indicating the effectiveness of the visualization method corresponding to the combination, for each analyst (step A4). Also, if a feedback score S_{F} is present, the visualization score calculation unit 3 calculates, using a relationship score S_{R} calculated with respect to a visualization method corresponding to a combination of features and the acquired feedback score S_{F}, the visualization score S_{V}, for each analyst (step A4). Specifically, in step A4, the visualization score calculation unit 3 calculates the visualization score S_{V} using the formula (6) or (7) or the like.

Next, the display information generation unit 4 selects, for each combination of features, a visualization method according to the visualization score S_{V}, and generates visualization display information for displaying a display corresponding to the selected visualization method in the display device 22 (step A5). Also, in step A4, if the visualization score S_{V} has changed, the display information generation unit 4 changes the display corresponding to the visualization method.

Specifically, in step A5, the display information generation unit 4 selects, by referring to the visualization scores S_{V} that are respectively associated with the visualization methods corresponding to the combination of features, as shown in FIG. 6, a visualization score S_{V} having the largest value, for each combination of features. Alternatively, in step A5, the display information generation unit 4 selects, by referring to the visualization scores S_{V} that are respectively associated with the visualization methods corresponding to the combination of features, as shown in FIG. 6, visualization scores S_{V} that are the threshold value or more, for each combination of features.

Next, in step A5, the display information generation unit 4 generates visualization display information for displaying the visualization methods selected for the respective combinations of features in the display device 22. Specifically, the display information generation unit 4 generates information for displaying a display as shown in FIG. 7 in the display device 22.

Next, operations for calculating the feedback score will be described using FIG. 10. When an analyst has made an analysis using a visualization method with respect to target data, the analyst makes a feedback regarding whether or not the visualization method used by the analyst is a visualization method suitable for the analyst.

The feedback score calculation unit 25, first, acquires feedback information indicating the evaluation degree of the analyst regarding the visualization method corresponding to a combination of features from the input device 21 (step B1). Specifically, the feedback information is input by the analyst using the input device 21, for example. Alternatively, a usage history of visualization methods used by the analyst may be input.

The feedback score calculation unit 25 determines whether or not feedback information indicating the evaluation degree of the analyst has been acquired with respect to the visualization method corresponding to a combination of features (step B2). If it is determined that the feedback information has been acquired (step B2: Yes), the feedback score calculation unit 25 calculates the feedback score S_{F} with respect to the visualization method corresponding to the combination of features based on the acquired feedback information (step B3). Note that if the feedback score calculation unit 25 has determined that the feedback information has not been acquired (step B2: No), the data analysis support apparatus 1 ends the processing for calculating the feedback score S_{F}.

Specifically, in step B3, the feedback score calculation unit 25 generates, for each analyst, feedback management information 41 in which a combination of features, a visualization method, a number of feedbacks for acquiring feedback information regarding a combination between the combination of features and the visualization method, and an evaluation degree indicated by the feedback information are associated.

Also, in step B3, the feedback score calculation unit 25 generates, for each analyst, partial feedback management information 51 in which a feature, a visualization method, a number of partial feedbacks that the partial feedback information regarding the combination of the feature and the visualization method is acquired, an evaluation degree indicated by the feedback information, and evaluation information calculated using the evaluation degree are associated.

Next, in step B3, the feedback score calculation unit 25 calculates the feedback score S_{F} using the evaluation information, the number of partial feedbacks, and the number of dimensions indicating the number of combinations of the features. For example, the feedback score calculation unit 25 calculates the feedback score S_{F} using formula (5).

[Effects According to Present Example Embodiment]

As described above, according to the present example embodiment, the visualization method is selected according to the visualization score, and a selected visualization method that is suitable for an analysis is presented to an analyst. Therefore, the time needed for the analyst to select a visualization method suitable for the analysis can be reduced.

Also, heretofore, an analyst uses a visualization method for analyzing target data, but it takes time for the analyst to select a visualization method suitable for the target data. However, the visualization method suitable for target data includes a method suitable for the analyst and a method that is not suitable for the analyst. As a result, merely selecting a visualization method suitable for target data simply is not sufficient for improving the efficiency of the analysis.

However, according to the present example embodiment, in addition to be able to present a visualization method suitable for data to be analyzed, a visualization method suitable for an analyst can also be presented, and therefore the time needed to select a visualization method suitable for the analysis can further be reduced relative to a known technique. Therefore, the time needed to select a visualization method can be reduced, out of the analysis time needed for the analysis, and as a result, the entire analysis time can be reduced.

Moreover, a display corresponding to only a visualization method in which features are related, or only a visualization method regarding which analysts frequently made feedbacks is displayed in the display device 22, and therefore the screen size of the display device 22 may be small.

[Program]

A program according to the present example embodiment need only be a program for causing a computer to perform steps A1 to A5 shown in FIG. 9 and steps B1 to B3 shown in FIG. 10. The data analysis support apparatus and the data analysis support method according to the present example embodiment can be realized by installing this program on a computer and executing the program. In this case, a processor of the computer functions as the feature extraction unit 24, the relationship score calculation unit 2, the feedback score calculation unit 25, the visualization score calculation unit 3, and the display information generation unit 4, and performs processing.

Also, the program according to the present example embodiment may also be executed by a computer system that includes a plurality of computers. In this case, for example, each of the computers may function as any of the feature extraction unit 24, the relationship score calculation unit 2, the feedback score calculation unit 25, the visualization score calculation unit 3, and the display information generation unit 4.

[Physical Configuration]

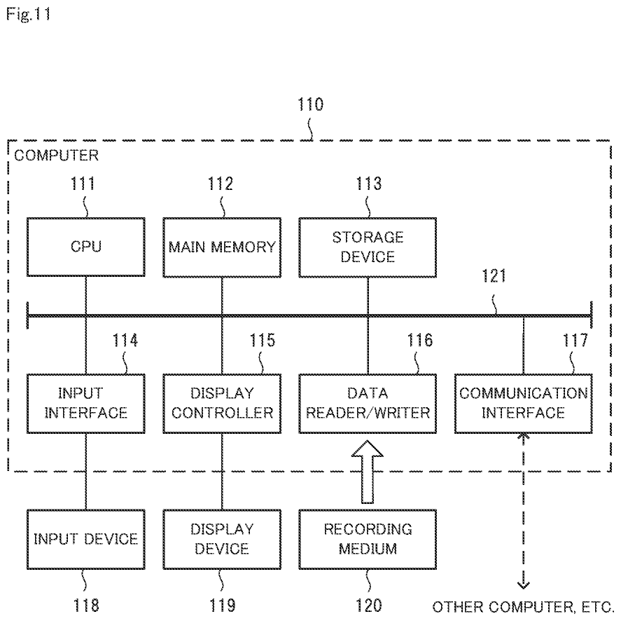

A description will now be given, with reference to FIG. 11, of a computer that realizes the data analysis support apparatus by executing the program according to the present example embodiment. FIG. 11 is a block diagram illustrating an example of a computer that realizes the data analysis support apparatus according to the present example embodiment of the present invention.

As shown in FIG. 11, a computer 110 includes a CPU 111, a main memory 112, a storage device 113, an input interface 114, a display controller 115, a data reader/writer 116, and a communication interface 117. These units are connected to each other via a bus 121 so as to be able to communicate data. Note that the computer 110 may also include, in addition to the CPU 111 or in place of the CPU 111, a GPU (Graphics Processing Unit), or an FPGA (Field-Programmable Gate Array).

The CPU 111 loads the program (codes) according to the present example embodiment that is stored in the storage device 113 to the main memory 112 and executes the program in a predetermined order, thereby performing various kinds of computation. The main memory 112 is typically a volatile storage device such as a DRAM (Dynamic Random Access Memory). The program according to the present example embodiment is provided in a state of being stored in a computer-readable recording medium 120. Note that the program according to the present example embodiment may also be distributed on the Internet to which the computer is connected via the communication interface 117.

Specific examples of the storage device 113 may include a hard disk drive, a semiconductor storage device such as a flash memory, and the like. The input interface 114 mediates data transmission between the CPU 111 and input devices 118 such as a keyboard and a mouse. The display controller 115 is connected to a display device 119 and controls a display in the display device 119.

The data reader/writer 116 mediates data transmission between the CPU 111 and the recording medium 120, reads out the program from the recording medium 120, and writes, in the recording medium 120, the results of processing performed by the computer 110. The communication interface 117 mediates data transmission between the CPU 111 and other computers.

Specific examples of the recording medium 120 may include a general-purpose semiconductor storage device such as a CF (Compact Flash (registered trademark)) or an SD (Secure Digital), a magnetic recording medium such as a Flexible Disk, and an optical recording medium such as a CD-ROM (Compact Disk Read Only Memory).

Note that the data analysis support apparatus 1 according to the present example embodiment may also be realized using hardware that corresponds to each of the units, rather than a computer in which the program is installed. Furthermore, the data analysis support apparatus 1 may be partially realized by a program, and the remainder may be realized by hardware.

### SUPPLEMENTARY NOTES

Part of, or the entire present example embodiment described above can be expressed by the following (Supplementary note 1) to (Supplementary note 18), but is not limited thereto.

(Supplementary Note 1)

A data analysis support apparatus including:

a relationship score calculation unit configured to calculate, with respect to a combination of features extracted from target data, a relationship score indicating a relationship between pieces of data corresponding to respective features included in the combination;

a visualization score calculation unit configured to calculate a visualization score indicating an effectiveness of a visualization method corresponding to the combination using the relationship score corresponding to the combination; and

a display information generation unit configured to select the visualization method according to the visualization score, and generate visualization display information for displaying a display corresponding to the selected visualization method on the display device.

(Supplementary Note 2)

The data analysis support apparatus according to supplementary note 1, further including:

a feedback score calculation unit configured to, with respect to the visualization method regarding the combination, acquire feedback information indicating an evaluation degree of an analyst, and calculate a feedback score based on the acquired feedback information,

wherein the visualization score calculation unit calculates, for each combination, the visualization score using the relationship score and feedback score corresponding to the combination.

(Supplementary Note 3)

The data analysis support apparatus according to supplementary note 2, wherein the feedback score calculation unit generates, for each analyst, first feedback management information in which the combination of features, the visualization method, a first number of feedbacks of acquiring the feedback information regarding a combination of the combination of features and the visualization method, and an evaluation degree indicated by the feedback information are associated.

(Supplementary Note 4)

The data analysis support apparatus according to supplementary note 3, wherein the feedback score calculation unit generates, for each analyst, second feedback management information in which the feature, the visualization method, a second number of feedbacks of acquiring the feedback information regarding a combination of the feature and the visualization method, an evaluation degree indicated by the feedback information, and evaluation information calculated using the evaluation degree are associated.

(Supplementary Note 5)

The data analysis support apparatus according to supplementary note 4, wherein the feedback score calculation unit calculates the feedback score using the evaluation information, the second number of feedbacks, and a number of dimensions in the combination of features.

(Supplementary Note 6)

The data analysis support apparatus according to any one of supplementary notes 1 to 5, wherein the display information generation unit changes a display corresponding to the visualization method according to the visualization score.

(Supplementary Note 7)

A data analysis support method including:

(a) a step of calculating, with respect to a combination of features extracted from target data, a relationship score indicating a relationship between pieces of data corresponding to respective features included in the combination;

(b) a step of calculating a visualization score indicating an effectiveness of a visualization method corresponding to the combination using the relationship score corresponding to the combination; and

(c) a step of selecting the visualization method according to the visualization score, and generating visualization display information for displaying a display corresponding to the selected visualization method on the display device.

(Supplementary Note 8)

The data analysis support method according to supplementary note 7, further including:

(d) a step of acquiring feedback information indicating an evaluation degree of an analyst, and calculating a feedback score based on the acquired feedback information, with respect to the visualization method regarding the combination,

wherein, in the (b) step, for each combination, the visualization score is calculated using the relationship score and feedback score corresponding to the combination.

(Supplementary Note 9)

The data analysis support method according to supplementary note 8, wherein, in the (d) step, for each analyst, first feedback management information is generated in which the combination of features, the visualization method, a first number of feedbacks of acquiring the feedback information regarding a combination of the combination of features and the visualization method, and an evaluation degree indicated by the feedback information are associated.

(Supplementary Note 10)

The data analysis support method according to supplementary note 9, wherein, in the (d) step, for each analyst, second feedback management information is generated in which the feature, the visualization method, a second number of feedbacks of acquiring the feedback information regarding a combination of the feature and the visualization method, an evaluation degree indicated by the feedback information, and evaluation information calculated using the evaluation degree are associated.

(Supplementary Note 11)

The data analysis support method according to supplementary note 10, wherein, in the (d) step, the feedback score is calculated using the evaluation information, the second number of feedbacks, and a number of dimensions in the combination of features.

(Supplementary Note 12)

The data analysis support method according to any one of supplementary notes 7 to 11, wherein, in the (c) step, a display corresponding to the visualization method is changed according to the visualization score.

(Supplementary Note 13)

A computer-readable recording medium that includes a program recorded thereon, the program including instructions that cause the computer to carry out:

(a) a step of calculating, with respect to a combination of features extracted from target data, a relationship score indicating a relationship between pieces of data corresponding to respective features included in the combination;

(b) a step of calculating a visualization score indicating an effectiveness of a visualization method corresponding to the combination using the relationship score corresponding to the combination; and

(c) a step of selecting the visualization method according to the visualization score, and generating visualization display information for displaying a display corresponding to the selected visualization method on the display device.

(Supplementary Note 14)

The computer readable recording medium according to supplementary note 13,

wherein the program further includes instructions that cause the computer to carry out:

(d) a step of acquiring feedback information indicating an evaluation degree of an analyst, and calculating a feedback score based on the acquired feedback information, with respect to the visualization method regarding the combination, and

wherein in the (b) step, for each combination, the visualization score is calculated using the relationship score and feedback score corresponding to the combination.

(Supplementary Note 15)

The computer readable recording medium according to supplementary note 14, wherein, in the (d) step, for each analyst, first feedback management information is generated in which the feature, the visualization method, a first number of feedbacks of acquiring the feedback information regarding a combination of the feature and the visualization method, an evaluation degree indicated by the feedback information, and evaluation information calculated using the evaluation degree are associated.

(Supplementary Note 16)

The computer readable recording medium according to supplementary note 15, wherein, in the (d) step, for each analyst, second feedback management information is generated in which the feature, the visualization method, a second number of feedbacks of acquiring the feedback information regarding a combination of the feature and the visualization method, an evaluation degree indicated by the feedback information, and evaluation information calculated using the evaluation degree are associated.

(Supplementary Note 17)

The computer readable recording medium according to supplementary note 16, wherein, in the (d) step, the feedback score is calculated using the evaluation information, the second number of feedbacks, and a number of dimensions in the combination of features.

(Supplementary Note 18)

The computer readable recording medium according to any one of supplementary notes 13 to 17, wherein, in the (c) step, a display corresponding to the visualization method is changed according to the visualization score.

The present invention of the present application has been described above with reference to the present example embodiment, but the present invention of the present application is not limited to the above present example embodiment. The configurations and the details of the present invention of the present application may be changed in various manners that can be understood by a person skilled in the art within the scope of the present invention of the present application.

### INDUSTRIAL APPLICABILITY

As described above, according to the present invention, a visualization method can be selected according to a visualization score, and the selected visualization method that is suitable for an analysis can be presented to an analyst, and therefore the time needed for the analyst to select a visualization method suitable for the analysis can be reduced. The present invention is useful in a field in which data analysis is needed.

### LIST OF REFERENCE SIGNS

1 Data analysis support apparatus
2 Relationship score calculation unit
3 Visualization score calculation unit
4 Display information generation unit
21 Input device
22 Display device
23 Storage device
24 Feature extraction unit
Feedback score calculation unit
41 Feedback management information
51 Partial feedback management information
61 Visualization method information
110 Computer
111 CPU
112 Main memory
113 Storage device
114 Input interface
115 Display controller
116 Data reader/writer
117 Communication interface
118 Input devices
119 Display device
120 Recording medium
121 Bus

What is claimed is:

1. A data analysis support apparatus comprising:
a relationship score calculation unit configured to calculate, with respect to a combination of features extracted from target data, a relationship score indicating a relationship between pieces of data corresponding to respective features included in the combination;
a visualization score calculation unit configured to calculate a visualization score indicating an effectiveness of a visualization method corresponding to the combination using the relationship score corresponding to the combination; and
a display information generation unit configured to select the visualization method according to the visualization score, and generating visualization display information for displaying a display corresponding to the selected visualization method on the display device.

2. The data analysis support apparatus according to claim 1, further comprising:
a feedback score calculation unit for, with respect to the visualization method regarding the combination, acquiring feedback information indicating an evaluation degree of an analyst, and calculating a feedback score based on the acquired feedback information,
wherein the visualization score calculation unit calculates, for each combination, the visualization score using the relationship score and feedback score corresponding to the combination.

3. The data analysis support apparatus according to claim 2, wherein the feedback score calculation unit generates, for each analyst, first feedback management information in which the combination of features, the visualization method, a first number of feedbacks of acquiring the feedback information regarding a combination of the combination of features and the visualization method, and an evaluation degree indicated by the feedback information are associated.

4. The data analysis support apparatus according to claim 3, wherein the feedback score calculation unit generates, for each analyst, second feedback management information in which the feature, the visualization method, a second number of feedbacks of acquiring the feedback information regarding a combination of the feature and the visualization method, an evaluation degree indicated by the feedback information, and evaluation information calculated using the evaluation degree are associated.

5. The data analysis support apparatus according to claim 4, wherein the feedback score calculation unit calculates the feedback score using the evaluation information, the second number of feedbacks, and a number of dimensions in the combination of features.

6. The data analysis support apparatus according to claim 1, wherein the display information generation unit changes a display corresponding to the visualization method according to the visualization score.

7. A data analysis support method comprising:
calculating, with respect to a combination of features extracted from target data, a relationship score indicating a relationship between pieces of data corresponding to respective features included in the combination;
calculating a visualization score indicating an effectiveness of a visualization method corresponding to the combination using the relationship score corresponding to the combination; and
selecting the visualization method according to the visualization score, and generating visualization display information for displaying a display corresponding to the selected visualization method on the display device.

8. The data analysis support method according to claim 7, further comprising:
acquiring feedback information indicating an evaluation degree of an analyst, and calculating a feedback score based on the acquired feedback information, with respect to the visualization method regarding the combination,
wherein, in the calculating the visualization score, for each combination, the visualization score is calculated using the relationship score and feedback score corresponding to the combination.

9. The data analysis support method according to claim 8, wherein, in the calculating the feedback score, for each analyst, first feedback management information is generated in which the combination of features, the visualization method, a first number of feedbacks of acquiring the feedback information regarding a combination of the combination of features and the visualization method, and an evaluation degree indicated by the feedback information are associated.

10. The data analysis support method according to claim 9, wherein, in the calculating the feedback score, for each analyst, second feedback management information is generated in which the feature, the visualization method, a second number of feedbacks of acquiring the feedback information regarding a combination of the feature and the visualization method, an evaluation degree indicated by the feedback information, and evaluation information calculated using the evaluation degree are associated.

11. The data analysis support method according to claim 10, wherein, in the calculating the feedback score, the feedback score is calculated using the evaluation information, the second number of feedbacks, and a number of dimensions in the combination of features.

12. The data analysis support method according to claim 7, wherein, in the generating visualization display information, a display corresponding to the visualization method is changed according to the visualization score.

13. A non-transitory computer-readable recording medium that includes a program recorded thereon, the program including instructions that cause the computer to carry out:
calculating, with respect to a combination of features extracted from target data, a relationship score indicating a relationship between pieces of data corresponding to respective features included in the combination;
calculating a visualization score indicating an effectiveness of a visualization method corresponding to the combination using the relationship score corresponding to the combination; and
selecting the visualization method according to the visualization score, and generating visualization display information for displaying a display corresponding to the selected visualization method on the display device.

14. The non-transitory computer readable recording medium according to claim 13,
wherein the program further includes instructions that cause the computer to carry out:
acquiring feedback information indicating an evaluation degree of an analyst, and calculating a feedback score based on the acquired feedback information, with respect to the visualization method regarding the combination, and
wherein in the calculating the visualization score, for each combination, the visualization score is calculated using the relationship score and feedback score corresponding to the combination.

15. The non-transitory computer readable recording medium according to claim 14, wherein, in the calculating the feedback score, for each analyst, first feedback management information is generated in which the feature, the visualization method, a first number of feedbacks of acquiring the feedback information regarding a combination of the feature and the visualization method, an evaluation degree indicated by the feedback information, and evaluation information calculated using the evaluation degree are associated.

16. The non-transitory computer readable recording medium according to claim 15, wherein, in the calculating the feedback score, for each analyst, second feedback management information is generated in which the feature, the visualization method, a second number of feedbacks of acquiring the feedback information regarding a combination of the feature and the visualization method, an evaluation degree indicated by the feedback information, and evaluation information calculated using the evaluation degree are associated.

17. The non-transitory computer readable recording medium according to claim 16, wherein, in the calculating the feedback score, the feedback score is calculated using the evaluation information, the second number of feedbacks, and a number of dimensions in the combination of features.

18. The non-transitory computer readable recording medium according to claim 13, wherein, in the generating visualization display information, a display corresponding to the visualization method is changed according to the visualization score.
